(19) United States
(12) Patent Application Publication
(10) Pub. No.: US 2006/0090180 A1
(43) Pub. Date: Apr. 27, 2006

(54) Use of screensaver to mask EPG data capture

(75) Inventor: K. Metin Uz, Eden Prairie, MN (US)

Correspondence Address: LSI LOGIC CORPORATION, 1621 BARBER LANE, MS: D-106, MILPITAS, CA, 95035, US

(73) Assignee: LSI LOGIC CORPORATION

(21) Appl. No.: 10/970,579

(22) Filed: Oct. 21, 2004

(51) Int. Cl. H04N 5/445; G06F 13/00; G06F 3/00

(52) U.S. Cl. 725/39

(57) ABSTRACT

A method for masking an electronic program guide data capture in a set-top box, comprising the steps of (A) determining whether the set-top box is active or inactive based on the frequency of user input, (B) if the set-top box is inactive, activating a screensaver, and (C) capturing the electronic program guide data.

### FIELD OF THE INVENTION

The present invention relates to electronic program guides generally and, more particularly, to a method and/or apparatus to use a screensaver to mask an electronic program guide data capture.

### BACKGROUND OF THE INVENTION

Electronic program guides (EPG) are typically used for set top boxes (STBs) such as digital video recorders (DVR), satellite receivers and/or cable receivers. In a digital video recorder, the electronic program guide is often downloaded from a centralized program server. The download often occurs at a time when the viewer is not using the DVR or the phone line that the DVR uses for the download. For example, a DVR may download the electronic program guide late at night when a user is not expected to use the DVR. However, the time of the download is selected based on the average persons sleep patterns. If the particular person that uses the DVR is using the DVR, the electronic program guide download may initiate during viewing of the DVR material. While some conventional DVRs record and download at the same time, others download EPG information using a soft-modem feature (e.g., implemented in software). Since a soft-modem feature uses CPU resources, a DVR with such an implementation may not be able to download and record at the same time. In such a case it is undesirable to view download information as it occurs, since such information is normally displayed as a percentage of the entire program guide that has been downloaded.

Certain conventional approaches carry electronic program guide data along with the video of specific channels. Recorders need to tune to one of these channels in order to capture program guide data. If the user does not put the recorder in standby, recorders that have only one tuner typically do not automatically change to this channel. Recorders that have only one tuner tune to this channel in order to capture program guide data. Furthermore, most personal video recorders today use a dial-up connection to download the program guide. In other cases, user manuals remind users to put the recorder in standby when not in use. If a user forgets to turn off their recorder with such a configuration, the program guide data will not be downloaded.

It would be desirable to provide a method and/or apparatus to mask the download of EPG data that uses a screensaver and/or an automatic timeout to tune the DVR to an appropriate channel.

### SUMMARY OF THE INVENTION

The present invention concerns a method for masking an electronic program guide data capture in a set-top box, comprising the steps of (A) determining whether the set-top box is active or inactive based on the frequency of user input, (B) if the set-top box is inactive, activating a screensaver, and (C) capturing the electronic program guide data.

The objects, features and advantages of the present invention include providing a screensaver to mask an EPG data capture that may (i) provide an esthetically pleasing display during an electronic program guide capture, (ii) provide a tuning and/or standby feature to remove the need to shut off a recorded to obtain guide information, (iii) provide a simple and intuitive system, (iv) be implemented without having to remember to turn off the recorder, (v) be implemented without annoying dialog boxes to tell a user what is about to happen, and/or (vi) reduce user complaints about product changing channels by itself.

### BRIEF DESCRIPTION OF THE DRAWINGS

These and other objects, features and advantages of the present invention will be apparent from the following detailed description and the appended claims and drawings in which:

FIG. 1 is a block diagram of a digital video recorder; and

FIG. 2 is a flow diagram of a preferred embodiment of the present invention.

### DETAILED DESCRIPTION OF THE PREFERRED EMBODIMENTS

The present invention may implement a method and/or apparatus to use a screensaver to mask an electronic program guide data capture. The present invention monitors a digital video recorder (DVR) or other set-top box (STB) for user activity. After a first period of user inactivity, a video output is switched to a screen saver. After waiting for a second period of inactivity, recording is paused or stopped. The present invention then switches the tuner to an EPG channel. When user input is detected, or after EPG data is captured, the tuner is switched back to the original channel and timeshift recording is resumed. The screen saver is also switched off after the EPG data transfer.

The particular type of screensaver may be varied to meet the design criteria of a particular implementation. For example, instead of a traditional screensaver, a page that says “No activity—going to standby in 3 minutes”, may be implemented. After moving to a standby state, a traditional screensaver (e.g., a picture, etc.) or a blank screen may be displayed.

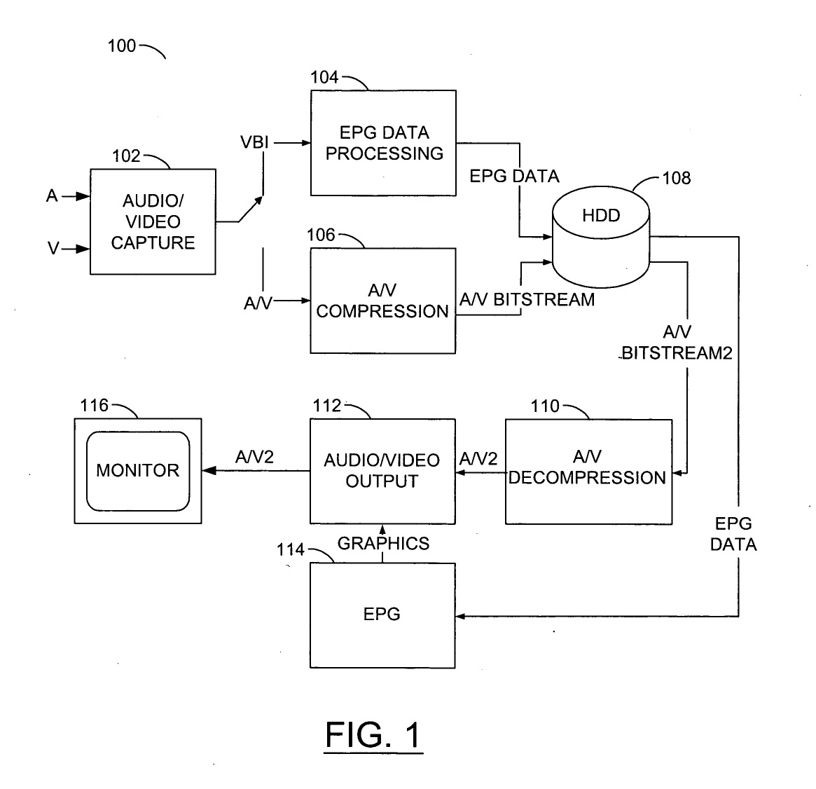

Referring to FIG. 1, a block diagram of a system 100 is shown illustrating an analog personal video recorder (PVR) or digital video recorder (DVR) that uses electronic program guide (EPG) data carried in the video signal. The system 100 generally comprises a block (or circuit) 102, a block (or circuit) 104, a block (or circuit) 106, a block (or circuit) 108, a block (or circuit) 110, a block (or circuit) 112, a block (or circuit) 114 and a block (or circuit) 116. The block 102 may be implemented as an audio/video capture circuit. The block 104 may be implemented as an EPG data processing block. The block 106 may be implemented as an audio/video compression circuit. The block 108 may be implemented as a storage device, such as a hard disc drive (HDD) or solid state memory. The block 110 may be implemented as an A/V decompression block. The block 112 may be implemented as an audio/video output block. The block 114 may be implemented as an electronic program guide (EPG) block. The block 116 may be implemented as a monitor or other type of display.

An incoming audio signal (e.g., A) and video signal (e.g., V) are generally captured by the block 102. When the circuit 100 enters data collection mode, the video signal (e.g., B) is routed to the EPG processing block 104. The EPG processing block extracts the data embedded in the signal VBI, which is typically carried by a local TV station. The signal VBI may be implemented as a vertical blanking interval signal. EPG data is extracted and then written to a database on the hard disk drive 108.

During normal operation, the incoming audio/video data signal (e.g., A/V) is compressed by the block 106 to generate a signal (e.g., A/V BITSTREAM). The block 106 may generate the signal A/V BITSTREAM by using MPEG, Dolby, and/or other compression standards. The compressed signal A/V BITSTREAM is written to a stream file on the storage device 108. The storage device 108 generates a signal (e.g., A/V BITSTREAM2). The A/V decompression block 110 generates a signal (A/V2) in response to the signal A/V BITSTREAM2. The block 112 presents the signal A/V2 to the monitor 116.

The signal A/V BITSTREAM2 presented to the block 110 is a stream file from the storage devices 108. The signal BITSTREAM2 normally represents either what is being currently recorded (“live” playback), or what was recorded earlier. Optionally, program guide data may be blended or superimposed on the video output, as produced by the block 114.

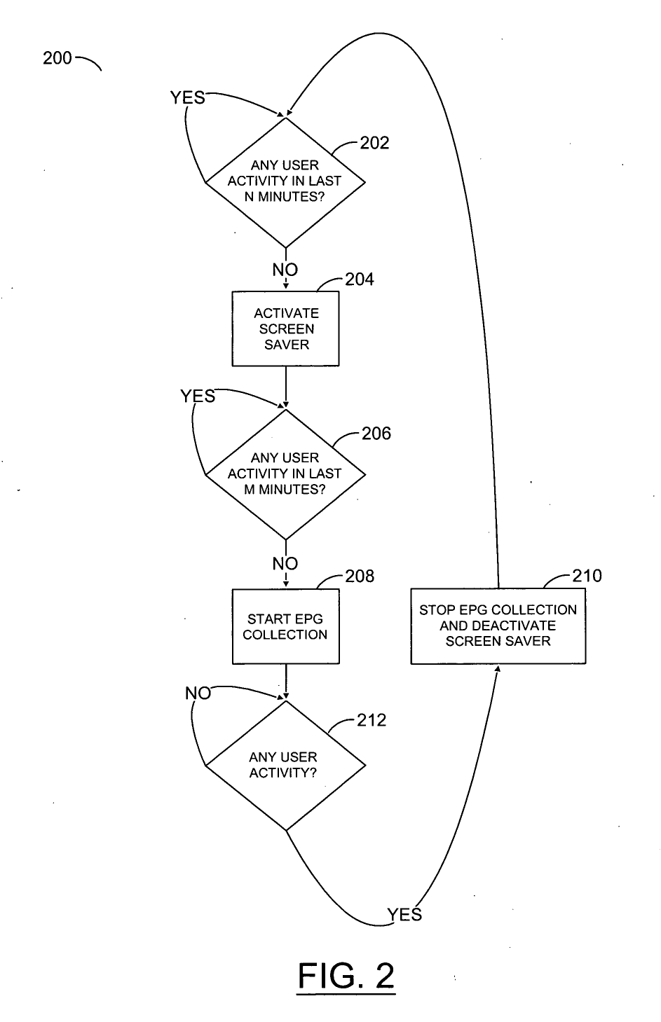

Referring to FIG. 2, a flow diagram of a method (or process) 200 is shown in accordance with the present invention. The process 200 generally comprises a decision state 202, a state 204, a decision state 206, a state 208, a state 210 and a decision state 212. The decision state 202 may determine if there is any user activity in the last N minutes, where N is a variable that may be an integer or a fraction of an integer. If there has been user activity, than the method 200 stays in the state 202. If there has been no activity, the method 200 moves to the state 204. The state 204 activates a predetermined screensaver.

Next, the state 206 determines if there has been any user activity in the last M minutes, where M is a variable that may be an integer or a fraction of an integer. The value N and the value M may be the same or different values. If there has been user activity, the method 200 stays in state 206. If there has not been activity, the method 200 moves to the state 208. The state 208 starts the electronic program guide collection process. Next, the state 212 determines if there has been any user activity. If not, the method 200 stays in the state 212. If there has been activity, the method moves to the state 210. The state 210 stops the EPG collection and deactivates the screensaver. After the state 210, the method returns to the state 202. When there is no user activity (e.g., remote control actions or front panel key actions) for a specified interval, the method 200 activates a screensaver, which is a stationary or moving pattern displayed on the screen, obstructing the video. This may be implemented by the block 114 of FIG. 1. Audio may also be muted during this time. If any key is pressed in the next interval, then the screensaver is de-activated. This indicates that someone was watching the output.

If there was no key pressed, then the system goes into data collection mode. Any existing recording is stopped or paused. The block 102 is tuned to the appropriate station, and video settings may be changed so that the appropriate blanking lines may be captured. This captured video is fed to the block 104, which extracts the information and writes it into a database on the hard disk drive. This update operation may take a certain time to complete, or it may continue until any user input is received.

When user activity is detected, the data collection is stopped, and input settings may be restored. In that case, the tuner is set to the previous channel, recording is started or resumed, and playback starts at an appropriate point. Then the screensaver is deactivated.

The function performed by the flow diagram of FIG. 2 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, FPGAs, or by interconnecting an appropriate network of conventional component circuits, as is described herein, modifications of which will be readily apparent to those skilled in the art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, magneto-optical disks, ROMS, RAMS, EPROMs, EEPROMs, Flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the spirit and scope of the invention. For example, while the invention is described in connection with a PVR with a hard disc, the invention also applies to recorders with removable media, such as DVD recorders. Furthermore, the EPG database may be implemented in a different media (such as non-volatile semiconductor memory (flash, EEPROM, NVRAM, etc.)) than the program information.

1. A method for masking an electronic program guide data capture in a set-top box, comprising the steps of:
(A) determining whether said set-top box is active or inactive based on the frequency of user input;
(B) if said set-top box is inactive, activating a screensaver; and
(C) capturing said electronic program guide data.

2. The method according to claim 1, further comprising the step of:
after said electronic program guide data has been captured, deactivating said screensaver.

3. The method according to claim 1, wherein step (C) further comprises:
tuning said set-top box to a predetermined channel to initiate said capture.

4. The method according to claim 1, wherein step (A) determines said activity or inactivity by determining whether any use input has occurred in the last N minutes, where N is a variable.

5. The method according to claim 1, further comprising the step of:
prior to step (C), determining whether any user input has occurred in the last M minutes, where M is a variable.

6. The method according to claim 1, further comprising the step of:
checking for user activity during said capture.

7. The method according to claim 6, wherein said capture is stopped if user activity occurs.

8. The method according to claim 6, wherein said capture continues if no user activity occurs.

9. An apparatus for masking an electronic program guide data capture in a set-top box, comprising:
means for determining whether said set-top box is active or inactive based on the frequency of user input;
means for if said set-top box is inactive, activating a screensaver; and
means for capturing said electronic program guide data.

10. The apparatus according to claim 9, further comprising:
means for deactivating said screensaver after said electronic program guide data has been captured.

11. An apparatus for masking an electronic program guide data capture in a set-top box, comprising:
a first section configured to determine whether said set-top box is active or inactive based on the frequency of user input;
a second section configured to (i) determine if said set-top box is inactive and (ii) activate a screensaver; and
a third section configured to capture said electronic program guide data.

12. The apparatus according to claim 11, wherein said apparatus deactivates said screensaver after said electronic program guide data has been captured.

13. The apparatus according to claim 11, wherein said apparatus tunes said set-top box to a predetermined channel to initiate said capture.

14. The apparatus according to claim 11, wherein said apparatus determines said activity or inactivity by determining whether any use input has occurred in the last N minutes, where N is a variable.

15. The apparatus according to claim 11, wherein said apparatus determines whether any user input has occurred in the last M minutes, where M is a variable.

16. The apparatus according to claim 11, wherein said apparatus checks for user activity during said capture.

17. The apparatus according to claim 11, wherein said capture is stopped if user activity occurs.

18. The apparatus according to claim 11, wherein said capture continues if no user activity occurs.

19. The apparatus according to claim 11, wherein said electronic program guide is captured on a separate media than one or more recorded programs.

20. The apparatus according to claim 11, wherein said set-top box comprises a hard disc drive recorder.

21. The apparatus according to claim 11, wherein said set-top box comprises a DVD recorder.
